(19) United States
(12) Patent Application Publication
(10) Pub. No.: US 2015/0088282 A1
(43) Pub. Date: Mar. 26, 2015

(54) TOUCH-LESS SWIPE CONTROL

(71) Applicant: Fibar Group sp. z o. o., Poznan (PL)

(72) Inventors: Maciej Fiedler, Poznan (PL); Bartlomiej Arcichowski, Poznan (PL)

(21) Appl. No.: 14/494,771

(22) Filed: Sep. 24, 2014

Related U.S. Application Data
(60) Provisional application No. 61/881,785, filed on Sep. 24, 2013.

(51) Int. Cl. G05B 15/02; G06F 3/01

(52) U.S. Cl. CPC G05B 15/02; G06F 3/017
USPC 700/83

(57) ABSTRACT

A touch-less swipe control system for use with a network to control a device of the network. The touch-less swipe control system may include a control mat to detect a touch-less gesture, and a processor coupled to the control mat to receive data indicative of the touch-less gesture, wherein the processor may be configured to recognize if the received data is associated with a control of the device. The touch-less swipe control system may include a communication transceiver to communicate the control to the device in response to having recognized that the received data is associated with a control of the device.

### CLAIM OF PRIORITY/INCORPORATION BY REFERENCE

The patent application makes reference to, claims priority to and claims benefit from U.S. Provisional Patent Application Ser. No. 61/881,785 entitled “Touch-Less Swipe Control” filed on Sep. 24, 2013, which is hereby incorporated herein by reference in its entirety.

### TECHNICAL FIELD

Aspects of the present disclosure relate to electronic systems and/or networking More specifically, certain implementations of the present disclosure relate to a touch-less swipe control.

### BACKGROUND

Existing methods and systems for providing device control can be costly, cumbersome and inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for a touch-less swipe control, substantially as shown in and/or described in connection with at least one of the figures, as set forth more completely in the disclosure and/or the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 illustrates an example home network.

FIG. 2 illustrates an example touch-less swipe control.

FIG. 3 illustrates an example flow chart of a method for an example process for managing one or more touch-less swipe controls.

### DETAILED DESCRIPTION

Certain implementations may be found in a method and system for a touch-less swipe control. In one embodiment, the invention provides a touch-less swipe control system for use with a home network to control a device of the home network. The touch-less swipe control system includes a control mat to detect a touch-less gesture, and a processor coupled to the control mat to receive data indicative of the touch-less gesture, and to recognize if the received data is associated with a control of the device. The touch-less swipe control system includes a communication transceiver, in response to having recognized that the received data is associated with a control of the device, to communicate the control to the device.

In another embodiment, the invention provides a touch-less swipe control system that includes a device to perform a function, and a home network manager coupled to the device to communicate control signals to the device. The system also includes a touch-less system that is coupled to the home network manager. The touch-less system includes a control mat to detect a touch-less gesture, a processor coupled to the control mat to receive data indicative of the touch-less gesture, and to recognize if the received data is associated with a control of the device, and a communication transceiver, in response to having recognized that the received data is associated with a control of the device, to communicate the received data to the home network manager. The home network manager further processes the received data to generate a control signal associated with the device and the received data, and to communicate the control signal to the device.

In another embodiment, the invention provides a method of controlling a device via a) a touch-less swipe control system being remote from the device, and b) a home network manager operable to communicate control signals to the device. The method includes detecting at the touch-less swipe control system a touch-less gesture, recognizing if the touch-less gesture is associated with a control of a device, and in response to having recognized that the touch-less gesture is associated with a control of a device, transmitting the received data to the home network manager. The method also includes generating a control signal at the home network manager based on the device and the touch-less gesture, and transmitting the control signal from the home network manager to the device.

As utilized herein the terms “circuits” and “circuitry” refer to physical electronic components (i.e. hardware) and any software and/or firmware (“code”) which may configure the hardware, be executed by the hardware, and/or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and/or “module” refer to functions than may be performed by one or more circuits. As utilized herein, the term “example” means serving as a non-limiting example, instance, or illustration. As utilized herein, the terms “for example” and “e.g.” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

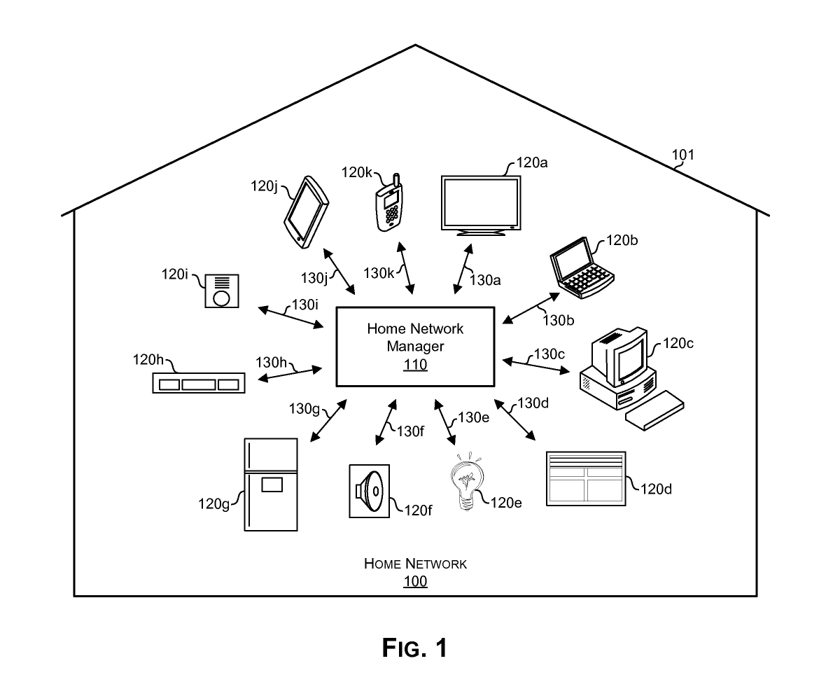

FIG. 1 illustrates an example home network. Referring to FIG. 1, there is shown a home network 100.

The home network 100 may correspond to a location 101. The location 101 may, for example, correspond to a residence (e.g., home, apartment) or non-residence premises (e.g., a small business, a school, a library). In this regard, the home network 100 may, for example, comprise a plurality of home network elements, such as, for example, a plurality of home network elements 120a-120k. The home network elements (e.g., home network elements 120a-120k) may, for example, comprise one or more devices, systems, fixtures, appliances, and/or other circuitry. The home network elements (e.g., home network elements 120a-120k) may comprise, for example, one or more televisions 120a, one or more computers (e.g., laptop computer 120b, desktop computer 120c), one or more personal handheld devices (e.g., tablet 120j, mobile phone 120k), one or more multimedia devices and/or components (e.g., speakers 120f), one or more structural fixtures (e.g., windows/window blinds 120d), one or more lighting and/or electrical fixtures 120e, one or more appliances (e.g., refrigerator 120g), one or more environmental sensory devices 120h (e.g., thermometers, humidity meters), and/or one or more security devices 120i (e.g., a smoke detector, a carbon monoxide detector, a security alarm, a motion detector).

The disclosure is not limited to any particular type of a home network. Furthermore, the disclosure is not limited to any particular combination of home network elements. It is to be understood that although the network is referred to as a “home network” throughout the disclosure, the disclosure is not limited in this way. Specifically, the network may comprise any other network that may be operable to control one or more network elements.

In some instances, the home network 100 may incorporate a home network manager 110. The home network manager 110 may comprise suitable circuitry, interfaces, logic, and/or code for implementing various aspects of the present disclosure. For example, the home network manager 110 may be configured for use in managing, servicing, and/or interacting with one or more home network elements. Although the home network manager 110 is shown in FIG. 1 as a single and separate device, the disclosure is not limited in this way. For example, in some implementations, one or more functions of the home network manager 110 may be provided by one or more existing home network elements (e.g., providing user interface via tablet 120j and/or television 120a). In an example embodiment of the disclosure, the home network manager 110 may be implemented as a virtual platform, such as, for example, one or more software modules may run on, and/or utilize resources of one or more existing home network elements (e.g., laptop 120b or desktop 120c).

The home network manager 110 may be configured to communicate with one or more elements (e.g., home network devices) in a home network. In an example embodiment of the disclosure, the home network manager 110 may be operable to communicate with one or more devices and/or systems that may be external to a home network, using, for example, optical, wired and/or wireless communication links.

The home network manager 110 may interact with one or more of the home network elements 120a-120k via corresponding links 130a-130k, which may be supported by the home network manager 110 and/or the corresponding home network element(s). For example, the links 130a-130k may be implemented and/or configured to operate using a wireless protocol, such as, for example, a Z-wave protocol. In an example embodiment of the disclosure, the home network 100 may be implemented as Z-Wave network. However, the disclosure is not limited in this way. For example, the home network 110 may comprise one or more wired and/or wireless links and/or protocol. Wireless links and/or protocols, may comprise, for example, WPAN (e.g., Bluetooth or ZigBee) and/or WLAN (WiFi/802.11) protocols and/or any other wireless links and/or protocols suitable for implementation consistent with the disclosure. Wired protocols and/or links may comprise, for example, Ethernet, Universal Serial Bus (USB), and/or any other wired links and/or protocols suitable for implementation consistent with the disclosure.

In an example implementation of the disclosure, the home network manager 110 may be operable to support one or more communication methods from one or more home network devices (e.g., home network elements 120a-120k). For example, one or more home network elements may communicate with the home network manager 110 utilizing a particular wireless link and/or protocol (e.g., Z-wave) and/or a particular wired link and/or protocol (e.g., Ethernet), while one or more other home network elements may communicate with the home network manager 110 utilizing a different particular wireless link and/or protocol (e.g., WiFi) and/or a different particular wired link and/or protocol (e.g., USB).

In an example embodiment of the disclosure, the same one or more home network elements may communicate with the home network manager 110 by, for example, using one or more wired and/or wireless links and/or protocols at the same and/or at different times. For example, a particular network element may communicate with the home network manager 110 using a Z-Wave communication protocol for a particular communication and may communicate with the home network manager 110 using a WiFi communication protocol for another particular communication.

In operation, the home network manager 110 may be operable to manage a home network (e.g., the home network 100). The home network manager 110 may be utilized, for example, as an interface platform for interacting with various network elements (e.g., the home network elements 120a-120k). In this regard, the home network manager 110 may support establishing and/or configuring one or more communication connections/links (e.g., the links 130a-130k) with the one or more elements of the home network 110. Once established, the connectivity between the home network manager 110 and the home network elements (e.g., elements 120a-120k) may, for example, be utilized to enable centralized monitoring, control, and/or management of the home network elements, and/or of the home network 100 as a whole. For example, the home network manager 110 may be operable to control operations of certain elements (e.g., turn on television 120a, switch to particular channel(s) at particular days/times, and/or record if recording is supported); monitor environment in the home network, such as by obtaining environmental readings (e.g., temperature, humidity, etc.) via example environmental sensory devices 120h, and may process these readings (e.g., to determine if/when to adjust other home network elements accordingly); adjust one or more example lighting and/or electrical fixtures 120e (e.g., turn lights on or off); lower/raise example window (blinds) 120d; adjust operations of example appliances (e.g., refrigerator 120g), such as, for example, based on a pre-configured power efficiency/optimization profile; monitor for any indications of a security/safety problem, based on, for example, input from example security devices 120i, and/or act accordingly (e.g., send notifications to users, such as by texting example smartphone 120k, and/or automatically notify authorities, e.g., by dialing ‘911’ and/or contacting pre-configured emergency numbers).

In an example embodiment of the disclosure, the home network manager 110 may provide and/or utilize user interface services in the home network. In this regard, the home network manager 110 may be operable to support use of user interface functions, and/or to generate and/or store information corresponding thereto, which may be utilized to enable interactions between the home network manager 110 and users (e.g., in the home network 100). For example, in some implementations, the home network manager 110 may be configured to generate and/or use a graphic user interface (GUI), for visually displaying information and/or providing interactivity with users (e.g., for providing input thereby). One or more user interfaces may enable configuring the home network manager 110 and/or functions provided by the home network manager 110. In an example embodiment of the disclosure, the one or more user interfaces may enable user interaction with, configuring and/or adjusting other elements in the home network 100 (e.g., elements connected to the home network manager 110).

In an example embodiment of the disclosure, the user interfaces may be provided via one or more other devices that may be communicatively coupled to the home network manager 110. For example, a GUI generated and/or used by the home network manager 110 may be displayed using existing home network elements, such as, for example, television 120a, laptop 120b, tablet 120j, and/or smartphone 120k.

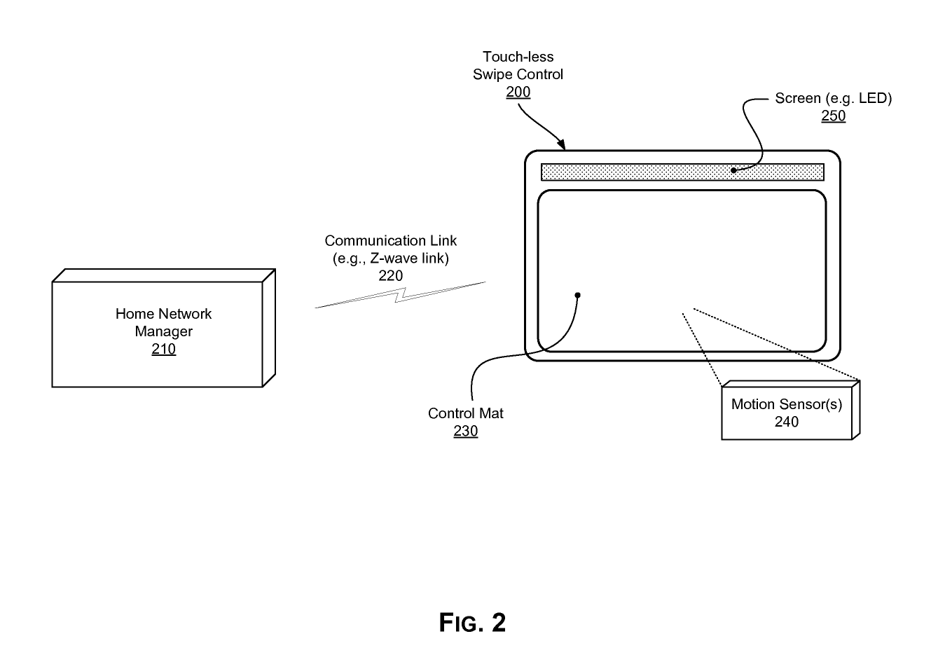

In an example embodiment of the disclosure, one or more home network elements (e.g., home network elements 120a-120k) may be configured to provide enhanced functionality, especially in the context of the home network provided by home network managers (e.g., the home network manager 110). For example, rather than utilizing a typical control interface, an enhanced touch-less swipe control may be utilized, such as to provide enhanced device control functions, device interface functions and/or other functions in a home network (e.g., the home network 100). An example touch-less swipe control is depicted in and/or described with respect to FIG. 2.

FIG. 2 illustrates an example touch-less swipe control. Referring to FIG. 2, there is shown a touch-less swipe control 200.

The touch-less swipe control 200 may comprise suitable circuitry, interfaces, logic, and/or code for implementing various aspects of the present disclosure. The touch-less swipe control 200 may be implemented and/or configured to provide enhanced touch-less control and/or related functions.

In an example embodiment of the disclosure, the touch-less swipe control 200 may be operable to receive and/or process control gestures. In this regard, touch-less swipe control 200 may issue a control command in response to a control gesture. In an another embodiment of the disclosure, the touch-less swipe control 200 may be operable to receive and/or process the control gestures and may be operable to communicate control gesture data to a network manager (e.g., home network manager 210) for further processing. In this regard, the network manager may issue a control command in response to a control gesture data received from the touch-less swipe control 200 and/or it may communicate control command data back to touch-less swipe control 200 for the touch-less swipe control 200 to issue a control command to a particular network element to which the control gesture was directed.

In an example embodiment of the disclosure, the touch-less swipe control 200 may be operable to learn, recognize and/or respond to custom control gestures. For example, touch-less swipe control 200 may be programmable with custom gestures. The touch-less swipe control 200 may receive and/or process the customer gestures and/or a user indication of a particular command and/or device that the custom gesture may be applicable to. In an example embodiment of the disclosure, the custom gestures may be stored within the touch-less swipe control 200 and/or within a network manager (e.g., home network manager 210.)

In an example embodiment of the disclosure, the touch-less swipe control 200 may be designed and/or built as an ultra-light device, with efficient and reliable power supply (e.g., driving power directly from electrical grid, and/or by incorporating efficient and/or long lasting 12/24 VDC batteries and/or other batteries and/or power sources).

For example, the touch-less swipe control 200 may be operable to provide functionality consistent with the disclosure while operating on battery power. For example, the touch-less swipe control 200 may comprise a built-in and/or replaceable battery (not shown) that may support the operation of the touch-less swipe control 200 during, for example, a power outage.

The touch-less swipe control 200 may be configured for operation on a home network (e.g., home network 100 as depicted in and/or described with respect to FIG. 1), such that, the touch-less swipe control 200 may be utilized as a home network element. In this regard, the touch-less swipe control 200 may be configured to interact, for example, in a home network (e.g., home network 100 as depicted in and/or described with respect to FIG. 1) with, for example, a home network manager (e.g., home network manager 210). The home network manager may be substantially similar to the home network manager 110 as depicted in and/or described with respect to FIG. 1.

For example, the touch-less swipe control 200 may be configured to interact with the home network manager 210 via a communication link 220. The communication link 220 may, for example, comprise a Z-Wave link. The disclosure is not limited to any particular type of a communication link. For example, the touch-less swipe control 200 may be implemented to support, for example one or more wireless and/or wired links, protocols and/or connections. For example, wireless links, protocols and/or connections, may comprise, for example, WPAN (e.g., Bluetooth or ZigBee) and/or WLAN (WiFi/802.11) protocols and/or any other wireless links, protocols and/or connections suitable for implementation consistent with the disclosure. Wired links, protocols and/or connections may comprise, for example, Ethernet, Universal Serial Bus (USB), and/or any other wired links, protocols and/or connections suitable for implementation consistent with the disclosure. While not shown in FIG. 2, to support communication with other elements or systems, such as the home network manager 210, the touch-less swipe control 200 may incorporate a communication transceiver (e.g., a Z-Wave transceiver) and/or related processing resources for allowing use of the touch-less swipe control 200.

The touch-less swipe control 200 may incorporate various features for providing enhanced device control related functions and/or operations. In this regard, the touch-less swipe control 200 may be designed and/or configured to perform as an extremely compact, intelligent and/or sophisticated control device for controlling one or more network elements (e.g., network elements 120a-120k) that may be connected to a home network (e.g., home network 100). For example, the touch-less swipe control 200 may be operable to allow control of one or more network elements (e.g., network elements 120a-120k), through gestures such that a user may not have to touch the touch-less swipe control 200 in order to activate a particular functionality of the touch-less swipe control 200, and/or other home network functionality.

The touch-less swipe control 200 may be operable to detect a control gesture (e.g., through a control mat, such as, for example, control mat 230, through one or more motion sensor(s), such as, for example, motion sensor(s) 240). In an example embodiment of the disclosure, the touch-less swipe control 200 may be operable to control one or more networks elements (e.g., networks elements 120a-120k). For example, the touch-less swipe control 200 may be operable to control one or more networks elements in response to, for example, a control gesture, through direct and/or indirect control of a particular network element. The touch-less swipe control 200 may control the particular network element by sending a control command to the particular network element. In the alternative, the touch-less swipe control 200 may control the particular network element indirectly through, for example, a network manager (e.g., home network manger 210). For example, the touch-less swipe control 200 may communicate with the network manager and/or may request from the network manager to control the particular network element in response to, for example, the control gesture.

In an example implementation of the disclosure, the touch-control swipe control 200 may be operable to receive feedback in response to a control command. For example, the touch-control swipe control 200 may initiate a control command to, for example, close window blinds (and/or any other control command). It this example, it may be desirable, for the touch-less swipe control 200 to receive feedback from a network element to which the command was sent to communicate back to the touch-less swipe control 200, for example, that the command had (or had not) been successfully carried out.

In an example embodiment of the disclosure, when the command was sent to a network manager (e.g., and not directly to a network element), the network manager may initiate one or more commands for carrying out the control command (e.g., closing window blinds) by controlling a network device that may be associated with the particular control command. The network manager may be operable to receive a response from the particular network device indicative of whether the command was successfully carried out (e.g., the window blinds were closed). The network manager may communicate with the touch-less swipe control 200. For example, the touch-less swipe control 200 may receive from the network manager information and/or data (e.g., on or more messages) that be indicative of whether the control command had been carried out successfully (e.g., window blinds were closed).

In an example embodiment of the disclosure, the touch-less swipe control 200 may, for example, in response to the feedback from the network manager, issue a visual and/or audible indication to the user who initiated the control command (and/or issue an indication to another device, such as, for example, a smartphone, a tablet) indicative of whether the command was successfully carried out. For example, the touch-less swipe control 200 may generate an audio signal (e.g., though an internal and/or external speaker (not shown)) and/or it may initiate a display of the information on a screen (e.g., screen 250), where the information may be indicative of whether the command was successfully carried out.

In another example embodiment of the disclosure, the touch-less swipe control 200 may communicate directly with a network element (e.g., without first communicating with a network manager) and/or may obtain feedback information directly from the network element to which a control command was issued.

In an example embodiment of the disclosure, the touch-less swipe control 200 may be operable to control a control network manager (e.g., home network manager 210). For example, the touch-less swipe control 200 may issue a control command to the network manager in repose to, for example, a control gesture, in order to control functionality specific to the network manager (e.g., activate user communication alerts, such as, for example, text message alerts).

In an example embodiment of the disclosure, the touch-less swipe control 200 may be operable to control the functionality of the touch-less swipe control 200 itself. For example, the touch-less swipe control 200 may be operable to receive and/or process control gestures that may be directed to controlling the touch-less swipe control 200 functionality, such as, for example, gesture detection range, screen (e.g., screen 250) control, etc.

In an example embodiment, the touch-less swipe control 200 may incorporate a control mat 230. The control mat may comprise one or more motion sensors 240.

The one or more motion sensors 240 may comprise suitable circuitry, interfaces, logic, and/or code for implementing various aspects of the present disclosure. For example, the one or more motion sensors 240 may comprise one or more near-field sensors, photo sensors, radio sensors and/or other sensors and/or circuitry that may be operable to detect control gestures consistent with the disclosure.

In an example embodiment of the disclosure, the touch-less swipe control 200 may comprise one or more control mats (e.g., control mat 230) that may be communicatively coupled to the touch-less swipe control 200. In an example embodiment of the disclosure, the one or more control mats may be placed in various locations of, for example, a home in order to facilitate control of one or more network elements (e.g., network elements 120a-120k) that may be placed in the vicinity of the particular control mat and/or that may be intended to be controlled by a particular control mat. For example, a control mat (e.g., control mat 250) may be placed under a table (e.g., glass table), behind a mirror, behind a wall paper, embedded in, for example, granite countertop and/or placed behind and or within other objects and/or materials that may visually (e.g., partially and/or fully) conceal the control mat. In this regard, a user gesture made in the proximity of the object (e.g., table, mirror, wall, countertop) may active desired feature of a home manager, one or more network elements and/or the touch-less swipe control 200 itself. For example, a user may be able to perform a particular gesture to arm an alarm, turn on/off a television, close window blinds, etc.

In an example embodiment of the disclosure, the one or more control mats may be implemented in different sizes and/or different number and/or types of sensors. The size and/or the type and/or number of sensors may determine the proximity of control gestures that may be detectable the control mat. For example, a larger mat may be operable to detect control gestures from a further distance and/or through a thicker material (e.g., granite). However, the disclosure is not limited in this way. Other implementation consistent with the disclosure may be utilized where the size and/or the number and/or types of sensor of the control mat may not be determinative of the sensitivity of the control mat with respect to the maximum distance for detecting control gestures.

In an example embodiment of the disclosure, the touch-less swipe control 200 and/or one of the one or more control mats (e.g., control mat 230) may be made out of flexible material and/or rigid material such that placing the touch-less swipe control 200 and/or one of the one or more control mats within or behind certain objects may be, for example, more easily implemented.

In an example embodiment of the disclosure, the touch-less swipe control 200 may comprise one or more ambient sensors (not shown), such as, for example, a temperature and/or a humidity sensor, etc. The information and/or data generated by the one or more ambient sensors may be processed by the touch-less swipe control device 200. The information and/or data (processed or unprocessed) may be communicated by the touch-less swipe control 200 to, for example, a network manager (e.g., home network manager 210) and/or any other device (e.g., a mobile phone 120k).

In an example embodiment, the touch-less swipe control 200 may incorporate a screen 250. The screen 250 may be operable to display information and/or data related to the operation and/or functionality of the touch-less swipe control 200. For example, the screen 250 may be operable to display information and/or data related to the status of the touch-less swipe control 200 (e.g., on/off, within network manager range), control commands (e.g., control command issued, processed), ambient conditions (e.g., temperature, humidity) and/or any other information and/or data that may be relevant to the operation of the touch-less swipe control 200, a home network (e.g., home network 100), a network manager (e.g., network manager 210) and/or any other device that may be connected (and/or was at any time connected) on the home network (e.g., network elements 120a-120k).

In an example embodiment of the disclosure, the screen 250 may be operable to display a visual control command feedback. For example, when a user performs a gesture associated with a particular control command, the touch-less swipe control 200 may display information and/or data that may be indicative of whether the command was recognized and/or processed. For example, the screen 250 may be operable to display text and/or other graphical information that may indicate to the user whether the command was recognized, processed and/or needs to be confirmed.

The disclosure is not limited to any particular screen. For example the screen may be implemented as part of the touch-less swipe control 200 and/or as a virtual platform, such as, for example, one or more software modules that may run on, and/or utilize resources of one or more existing home network elements (e.g., laptop 120b or desktop 120c) and/or a network manager (e.g., network manger 210).

In an example embodiment of the disclosure, the touch-less swipe control 200 may be operable to receive, process and/or generate a voice command and/or feedback. For example, if a user issues a gesture control command (e.g., to arm an alarm), the touch-less swipe control 200 may acknowledge receipt of the command with an audible feedback (e.g., tone pattern/sequence, other voice message, such as, for example, “the alarm will be armed in 60 seconds”). In another example embodiment of the disclosure, the touch-less swipe control 200 may request that a user confirm that the user intended a particular command to be carried out, by for example generating a voice feedback (e.g., voice message, such as, for example, “are you sure you want to arm the alarm?”). The touch-less swipe control 200 may be operable to receive and/or process user response to the feedback. For example, a particular gesture may be used by a user to confirm the command and another particular gesture may be used by a user to cancel the request.

In an example embodiment of the disclosure, the touch-less swipe control 200 may be operable to receive a cancellation gesture even if the touch-less swipe control 200 did not issue a feedback request for a confirmation of a command.

Although the touch-less swipe control is illustrated as a separate device, the disclosure is not limited in this way. For example, touch-less swipe control 200 may be implemented as a part of another device, such as, for example, a home thermostat, ta network manager, etc.

In an example embodiment of the disclosure, the functionality of the touch-less swipe control 200 associated with, for example, command control confirmation, may be implemented through visual feedback. For example, information indicative of a need for a user to confirm a command initiated with a particular command gesture may be solicited through for example display of particular information on a screen (e.g., screen 250).

In an example embodiment of the disclosure, the touch-less swipe control 200 may carry out a control command when, for example, the user does not confirm the command within a pre-defined and/or per-configured time interval. In another embodiment of the disclosure, the touch-less swipe control 200 may cancel ta control command if, for example, the user does not confirm that the command should be carried out within a pre-determined and/or pre-configured time interval.

In an example embodiment of the disclosure, the touch-less swipe control 200 may be operable to provide a user with functionality to, for example, set and/or program which particular control command(s) require a command confirmation, what the pre-determined and/or pre-configured time interval should be and/or whether the command should be automatically confirmed and/or automatically cancelled on the lapse of the time interval.

In an example embodiment of the disclosure, the touch-less swipe control 200 may comprise an input/output (“I/O”) interface (not shown). The I/O interface may comprise suitable logic, circuitry, interfaces, and/or code that may be operable to enable user interactions with the touch-less swipe control 200 through interfaces other than, for example, the control gestures consistent with the disclosure. The I/O interface may, obtain input from user(s) of the touch-less swipe control 200 and/or provide output to the user(s). The I/O interface may support various types of inputs and/or outputs, including, for example, video, audio, and/or textual. In this regard, dedicated I/O devices and/or components, external to or integrated within the touch-less swipe control 200, may be utilized for inputting and/or outputting data during operations of the I/O interface. Exemplary (external or integrated) I/O devices may comprise displays, mice, keyboards, touchscreens, voice input interfaces, and other input/output interfaces or devices.

In an example embodiment of the disclosure, the touch-less swipe control 200 may incorporate a wireless range tester (not shown) that may be operable to, for example, determine whether the touch-less swipe control 200 is within a range of a home network manager (e.g., home network manager 210). In this regard, the touch-less swipe control 200 may be operable to generate an alarm condition when the touch-less swipe control 200 is not within a rage on any home network manager (e.g., home network manager 210) and/or when the touch-less swipe control 200 that, for example, was previously within the range of a (e.g., home network manager 210), is now outside of that range. In an example embodiment of the disclosure, the alarm condition may active one or more alarm indicators to generate indicate an alarm condition by, for example, generating an audible and/or a visual alarm. In an example embodiment of the disclosure, the alarm condition may be indicated on a screen (e.g., screen 250).

In another example embodiment of the disclosure, the home network manager 210 may be operable to generate an alarm condition, when for example, the touch-less swipe control that, for example, was previously within the range of the home network manager 210, is now outside of that range.

In an example embodiment of the disclosure, the touch-less swipe control 200 may comprise other suitable circuitry, interfaces, logic, and/or code for implementing various aspects of the present disclosure. For example, the touch-less swipe control 200 may comprise a memory and/or a processor.

The memory may store, for example, configuration data, which may comprise parameters and/or code, comprising software and/or firmware. The memory may comprise different memory technologies, including, for example, read-only memory (ROM), random access memory (RAM), low latency nonvolatile memory, flash memory, solid-state drive (SSD), field-programmable gate array (FPGA), and/or other suitable electronic data storage capable of storing data, code and/or other information.

In an example embodiment of the disclosure, the touch-less swipe control 200 may be operable to receive software and/or firmware updates. For example, the touch-less swipe control 200 may receive software and/or firmware updates from a network manager (e.g., the home network manager 210). In an example embodiment of the disclosure the software and/or hardware updates may be received, processed and/or installed automatically and/or manually. For example, the process may be completely automatic (e.g., a network manager may send an update to the touch-less swipe control and the touch-less swipe control may process it automatically), semi-automatic (e.g., an update may be initiated by a user through, for example, a network manager and/or through an interface on the touch-less swipe control, and may, for example, be processed by the touch-less swipe control automatically) and/or manual (e.g., an update may be initiated by a user through, for example, a network manager and/or through an interface on the touch-less swipe control, and may, for example, be processed by the touch-less swipe control in response to a user action indicative of a desire to install the particular update (e.g., through an interface)).

The processor may comprise suitable circuitry, interfaces, logic, and/or code that may be operable to process data, and/or control and/or manage components, operations and/or functions of the touch-less swipe control 200, and/or tasks performed therein. In this regard, the processor may configure and/or control operations of various components and/or subsystems of the touch-less swipe control 200, such as, for example, the memory, the communication subsystem (e.g., for communicating with, for example, the home network manager 210), the control mat 230, the motion sensor(s) 240 and/or the screen 250, etc. by utilizing, one or more control signals.

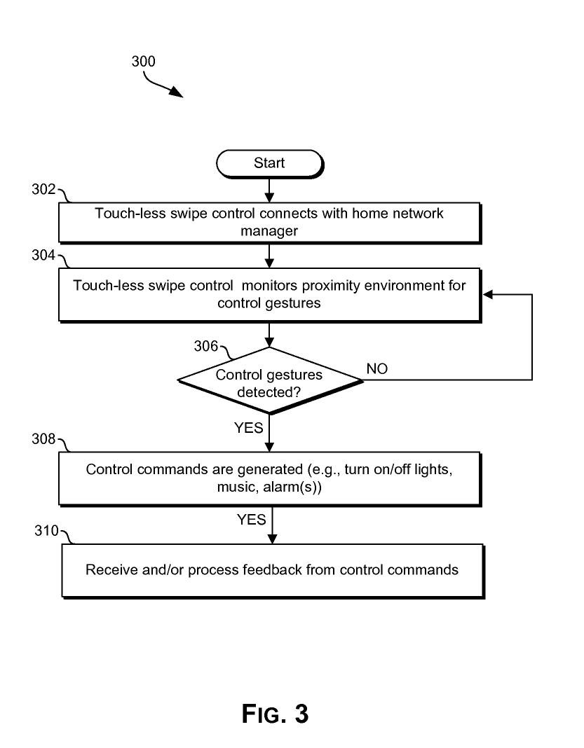

FIG. 3 illustrates an example flow chart of a method for an example process for managing one or more touch-less swipe controls. Referring to FIG. 3, there is shown a flow chart 300 comprising a plurality of example steps.

In example step 302, a touch-less swipe control (e.g., the touch-less swipe control 200 as depicted in and/or described with respect to FIG. 2) may connect with a home network manager (e.g., the home network manager 210 as depicted in and/or described with respect to FIG. 2). The connection may comprise a communication link (e.g., the communication link 220 as depicted in and/or described with respect to FIG. 2), such as, for example, a Z-Wave link. The connection may comprise one or more types of wireless and/or wired connections. The connecting may, in some instances, comprise determining whether the touch-less swipe control is within range of the home network manager. In this regard, the touch-less swipe control may incorporate a wireless range tester for determining whether the touch-less swipe control is within a range of a home network manager as described with respect to FIG. 2, for example.

In example step 304, the touch-less swipe control may monitor proximity environment (e.g., within a pre-defined and/or preconfigured plane and/or space) for control gestures, which may comprise, for example, pre-defined and/or pre-configured gestures. In this regard, the touch-less swipe control may utilize one or more sensors, such as, for example, motion sensor(s) (e.g., motion sensor(s) 240 depicted in and/or described with respect to FIG. 2).

In example step 306, it may be determined whether a control gesture is detected, and in instances where no control gesture is detected, the process may loop back to the example step 304 for continuing and/or periodic monitoring. Returning to the example step 306, in instances where a control gesture is detected, the process may proceed to example step 308.

In example step 308, one or more control commands may be generated. The control commands may comprise data and/or information, such as, for example, messages, that may be sent to a network manager (e.g., home network manager 201) and/or one or more network elements (e.g., network elements 120a-120k) for controlling the network manager and/or the one or more network elements, respectively. In an example embodiment of the disclosure, the control commands may comprise commands designed for controlling the touch-less swipe control (e.g., commands for programming new control commands/gestures for operating a home network manager, a network element and/or the touch-less swipe control).

In example step 310, feedback may be received and/or processed from the control commands generated in the example step 308. For example, in response to some control commands, it may be desirable to receive a command feedback. The feedback may be utilized to alert the user who initiated the control command of whether the command has been successfully carried out and/or in order to solicit from the user a confirmation whether a particular control command should be carried out.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for a touch-less swipe control.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A touch-less swipe control system for use with a network to control a device of said network, the touch-less swipe control system comprising:
a control mat configured to detect a touch-less gesture;
a processor coupled to said control mat, wherein the processor is configured to receive data indicative of said touch-less gesture, and wherein the processor is further configured to recognize if the received data is associated with a control of said device of said network; and
a communication transceiver, configured to communicate said control to said device in response to the processor having recognized that the received data is associated with a control of said device.

2. A touch-less swipe control system of claim 1 further comprising:
an interface coupled to said communication transceiver, wherein said communication transceiver is further configured to receive a feedback from said device of said network indicative of said control having been carried out, and wherein said interface is configured to present said feedback indicative of said control having been carried out.

3. A touch-less swipe control system of claim 2, wherein said processor is further configured to generate a cancellation signal, in response to not receiving said feedback within a predetermined interval, and wherein said communication transceiver is further configured to communicate said cancellation signal to cancel said control of said device.

4. A touch-less swipe control system of claim 2, wherein said interface comprises a display configured to display said feedback.

5. A touch-less swipe control system of claim 1 further comprising a network manager coupled to said network, wherein said communication transceiver is further configured to send said control to said network manager.

6. A touch-less swipe control system of claim 5, wherein said network manager is configured to generate a second control from said control, and wherein said network manager is further configured to control said device with said second control.

7. A touch-less swipe control system of claim 1, wherein said processor is further configured to be programmable, and wherein said processor is further configured to receive a control program so as to program an operation of said device via said control mat with another touch-less gesture.

8. A touch-less swipe control system of claim 1, wherein said communication transceiver is configured to communicate via Z-wave link.

9. A touch-less swipe control system comprising:
a device configured to perform a function;
a network manager coupled to said device, wherein said network manager is configured to communicate control signals to said device; and
a touch-less system coupled to said network manager, the touch-less system comprising:
a control mat configured to detect a touch-less gesture;
a processor coupled to said control mat, wherein the processor is configured to receive data indicative of said touch-less gesture, and wherein the processor is further configured to recognize if the received data is associated with a control of said device of said network; and
a communication transceiver, configured to communicate said control to said device in response to the processor having recognized that the received data is associated with a control of said device; and
wherein said network manager is further configured to process said received data, to generate a control signal associated with said device and said received data, and to communicate said control signal to said device.

10. A touch-less swipe control system of claim 9, wherein said touch-less system further comprises an interface coupled to said communication transceiver, and wherein said communication transceiver is further configured to receive a feedback from said device of indicative of an operation associated with said control signal having been carried out, and wherein said interface is configured to present said feedback indicative of an operation associated with said control signal having been carried out.

11. A touch-less swipe control system of claim 10, wherein said processor is further configured to generate a cancellation signal, in response to not receiving said feedback within a predetermined interval, and wherein said communication transceiver is further configured to communicate said cancellation signal to cancel said operation at said device.

12. A touch-less swipe control system of claim 10, wherein said interface comprises a display configured to display said feedback.

13. A touch-less swipe control system of claim 9, wherein said processor is further configured to be programmable, and to receive a control program so as to program an operation of a second device via said control mat with another touch-less gesture.

14. A touch-less swipe control system of claim 9, wherein said network manager is further configured to receive an operational program to control said device, and said control mat is further configured to recognize a different gesture associated with said operational program.

15. A touch-less swipe control system of claim 9, wherein said communication transceiver is configured to communicate via Z-wave link.

16. A method of controlling a device via a) a touch-less swipe control system being remote from said device, and b) a network manager operable to communicate control signals to said device, the method comprising:
detecting at the touch-less swipe control system a touch-less gesture;
recognizing by the touch-less swipe control system if said touch-less gesture is associated with a control of said device;
in response to having recognized that said touch-less gesture is associated with a control of said device, transmitting by the touch-less swipe control system said received data to said network manager;
generating a control signal at said network manager based on said device and said touch-less gesture; and
transmitting by the network manager said control signal from said network manager to said device.

17. A method of claim 16, further comprising:
receiving by the network manager a feedback from said device indicative of an operation associated with said control signal having been carried out;
transmitting said feedback by the network manager to the touch-less swipe control system;
displaying on the ouch-less swipe control system information relating to said feedback indicative of an operation associated with said control signal having been carried out by said device.

18. A method of claim 17, further comprising:
generating by the network manager a cancellation signal from said touch-less swipe control system, in response to not receiving said feedback within a predetermined interval; and
communicating from said touch-less swipe control system to said device said cancellation signal to cancel said operation at said device.

19. A method of claim 16, wherein said processor is further configured to be programmable, the method further comprising receiving a control program to program an operation of a second device via said touch-less swipe control system with another touch-less gesture.

20. A method of claim 16, wherein said processor is further configured to be programmable, the method further comprising:
receiving at said network manager an operational program to control said device; and
recognizing at said touch-less swipe control system a different gesture associated with said operational program.
